(19) United States
(12) Patent Application Publication
(10) Pub. No.: US 2022/0098383 A1
(43) Pub. Date: Mar. 31, 2022

(54) METHOD FOR PREPARING POLYURETHANE FOAMS

(71) Applicant: BASF SE, Ludwigshafen am Rhein (DE)

(72) Inventors: Bang Wei Xi, Shanghai (CN); YingHao Liu, Shanghai (CN); Wei Liang Chien, Shanghai (CN); Jin Lin Liu, Shanghai (CN); Bo Chen, Shanghai (CN)

(21) Appl. No.: 17/426,539

(22) PCT Filed: Jan. 28, 2020
(86) PCT No.: PCT/EP2020/052042

§ 371 Date: Jul. 28, 2021

(30) Foreign Application Priority Data
Feb. 1, 2019 (CN) PCT/CN2019/074454

(51) Int. Cl. C08J 9/14; C08G 18/76; C08G 18/66; C08G 18/48; C08G 18/42; C08G 18/40; C08G 18/32

(52) U.S. Cl. CPC C08J 9/146; C08G 18/7664; C08G 18/6607; C08G 18/4829; C08J 2375/08; C08G 18/4018; C08G 18/3221; C08G 18/3206; C08G 2110/0058; C08G 18/4211

(57) ABSTRACT

Described herein is a method for preparing polyurethane foams, including (1) placing a reaction mixture into a pressurizable chamber, and (2) polymerizing the reaction mixture at an additional pressure, where the reaction mixture comprises an isocyanate, an isocyanate-reactive compound and a blowing agent, and the reaction mixture is placed into the pressurizable chamber at a packing factor of 2.0-4.0. Also described herein is a polyurethane foam prepared by such a method.

### TECHNICAL FIELD

The present invention relates to a method for preparing polyurethane foams. The invention also relates to polyurethane foams prepared by said method.

### BACKGROUND OF ART

At present, polyurethane (PU) foams are used in many applications because of their broad properties. For obtaining PU foams having different properties, various methods are used. Generally, methods can be carried out under atmosphere pressure, reduced pressure or elevated pressure.

WO 2012/076375A1 discloses a method of making a molded rigid polyurethane foam comprising: injecting into a closed mold cavity a reaction mixture at a packing factor of 1.03 to 1.9, wherein the mold cavity is under a pressure of from 300 to 950 mbar, wherein the reaction mixture comprises: a) an organic polyisocyanate; b) a polyol composition; c) a catalyst; d) optionally auxiliary substances and/or additives; and e) a chemical blowing agent component in an amount of from 1 to 5 weight percent based on the total weight of components b) to e), the chemical blowing agent component comprising at least one chemical blowing agent, wherein the chemical blowing agent component is the sole blowing agent.

WO 2013/174844A1 discloses a method of making a polyisocyanurate (PIR) foam, comprising: A) injecting a reaction mixture into a closed mold cavity, wherein said mold cavity is under an absolute pressure of from 300 to 950 mbar; and B) curing to form a polyisocyanurate foam.

WO 2015/008313A1 discloses a method of forming a polyurethane foam, comprising: injecting a composition for forming a polyurethane foam under foam-forming conditions into a mold at a reduced pressure of at least 5000 pascal below standard pressure of 100 kilopascal; curing the composition for forming the polyurethane foam in the mold; and demolding the polyurethane foam from the mold.

U.S. Pat. No. 4,777,186 discloses a process for preparing flexible polyurethane foams at an elevated pressure to prevent the resulting polymer from completely filling the chamber.

U.S. Pat. No. 6,716,890B1 discloses a method for producing a durable polyurethane foam, comprising the steps of: (1) preparing a reaction mixture comprising: (a) a polyol mixture; (b) toluene diisocyanate; and (c) water as a blowing agent; and (2) allowing said reaction mixture to react while held at a pressure of about 1.0 to 1.5 bar (absolute) so as to form the polyurethane foam.c

However, as the requirement for high efficiency production of PU foam increases, there is a need to find a method for preparing polyurethane foams quickly without changing the desired foam density, while the resulting polyurethane foams show more homogeneously distributed cell size, which can result in better mechanical and thermal properties.

### INVENTION SUMMARY

Thus, the present invention provides a method for preparing polyurethane foams, comprising:

(1) placing a reaction mixture into a pressurizable chamber, and

(2) polymerizing the reaction mixture at an additional pressure,

wherein the reaction mixture comprises an isocyanate, an isocyanate-reactive compound and a blowing agent, and the reaction mixture is placed into the pressurizable chamber at a packing factor of 2.0-4.0.

The present inventions also provides a polyurethane foam prepared by the method above.

The method of the present invention can prepare polyurethane foams quickly without changing the desired foam density, and the resulting polyurethane foam has uniform cells which are needed for excellent mechanical and thermal properties. This method can be used for both molded and free rise foam.

### DESCRIPTION OF THE DRAWINGS

FIG. 1 shows a device for preparing the polyurethane foams.

FIG. 2 shows a SEM (scanning electron microscope) graph according to comparative example 1.

FIG. 3 shows a SEM (scanning electron microscope) graph according to comparative example 2.

FIG. 4 shows a SEM (scanning electron microscope) graph according to example 1.

### EMBODIMENTS

The isocyanate (i.e. diisocyanate or polyisocyanate) comprises aliphatic isocyanate, aromatic isocyanate, polymeric MDI, isocyanate prepolymer or combination thereof.

Particularly, the isocyanate comprises toluene diisocyanate (TDI), diphenylmethane diisocyanate (MDI), polymeric diphenylmethane diisocyanate (PMDI), 1,5-Naphthalene diisocyanate (NDI), Dimethyl-biphenyl diisocyanate (TODI), Hexamethylene diisocyanate (HDI), Isophorone diisocyanate (IPDI), Dicyclohexylmethane diisocyanate (H12MDI), Meta-tetramethylxylylene diisocyanate (TMXDI), et al, isocyanate group terminated prepolymers, and a mixture thereof.

As an isocyanate-reactive compound, it is possible to use all compounds which have at least two groups which are reactive toward isocyanates, e.g. OH-, SH-, NH- and CH-acidic groups. In one embodiment of the present invention, the isocyanate-reactive compound comprises polyether polyol, polyester polyol and combination thereof.

The polyether polyols are obtained by known methods, for example by anionic polymerization of alkylene oxides with addition of at least one starter molecule which comprises from 2 to 8 reactive hydrogen atoms in the presence of catalysts. As catalysts, it is possible to use alkali metal hydroxides such as sodium or potassium hydroxide or alkali metal alkoxides such as sodium methoxide, sodium or potassium ethoxide or potassium isopropoxide or, in the case of cationic polymerization, Lewis acids such as antimony pentachloride, boron trifluoride etherate or bleaching earth as catalysts. Furthermore, double metal cyanide compounds, known as DMC catalysts, can also be used as catalysts.

As alkylene oxides, preference is given to using one or more compounds having from 2 to 4 carbon atoms in the alkylene radical, e.g. tetrahydrofuran, 1,3-propylene oxide, 1,2- or 2,3-butylene oxide, in each case either alone or in the form of mixtures, and preferably ethylene oxide and/or 1,2-propylene oxide.

Possible starter molecules are, for example, ethylene glycol, diethylene glycol, glycerol, trimethylolpropane, pentaerythritol, sugar derivatives such as sucrose, hexitol derivatives such as sorbitol, methylamine, ethylamine, isopropylamine, butylamine, benzylamine, aniline, toluidine, toluenediamine, naphthylamine, ethylenediamine, diethylenetriamine, 4,4′-methylenedianiline, 1,3-propanediamine, 1,6-hexanediamine, ethanolamine, diethanolamine, triethanolamine and other dihydric or polyhydric alcohols or monofunctional or polyfunctional amines.

Polyether polyols can also include polytetrahydrofuran (PTHF), natural oil-based polyols like castor oil or also alkoxylated modified natural oils or fatty acids.

The polyester polyols used are usually prepared by condensation of polyfunctional alcohols e.g. ethylene glycol, diethylene glycol, butanediol, trimethylolpropane, glycerol or pentaerythritol, with polyfunctional carboxylic acids, for example succinic acid, glutaric acid, adipic acid, suberic acid, azelaic acid, sebacic acid, decanedicarboxylic acid, maleic acid, fumaric acid, phthalic acid, isophthalic acid, terephthalic acid, the isomers of naphthalenedicarboxylic acids or the anhydrides of the acids mentioned. This includes also other sources of dicarboxylic acids like dimethylterephthalate (DMT), polyethyleneglycol-terephthalate (PET) and the like.

As further starting materials in the preparation of the polyester alcohols, it is also possible to make concomitant use of hydrophobic materials. The hydrophobic materials are water-insoluble materials comprising a nonpolar organic radical and also having at least one reactive group selected from among hydroxyl, carboxylic acid, carboxylic ester and mixtures thereof. It is possible to use, for example, fatty acids such as stearic acid, oleic acid, palmitic acid, lauric acid or linoleic acid and also fats and oils such as castor oil, maize oil, sunflower oil, soybean oil, coconut oil, olive oil or tall oil.

The compound having groups which are reactive toward isocyanates further comprises chain extenders and/or crosslinkers. As chain extenders and/or crosslinkers, use is made of, in particular, bifunctional or trifunctional amines and alcohols, in particular diols, triols or both. Here, bifunctional compounds are referred to as chain extenders and trifunctional or higher-functional compounds are referred to as crosslinkers. It is possible to use, for example, aliphatic, cycloaliphatic and/or aromatic diols having from 2 to 14, preferably from 2 to 10, carbon atoms, e.g. ethylene glycol, 1,2-, 1,3-propanediol, 1,2-, 1,3-pentanediol, 1,10-decanediol, 1,2-, 1,3-, 1,4-dihydroxycyclohexane, diethylene glycol and triethylene glycol, dipropylene glycol and tripropylene glycol, 1,4-butanediol, 1,6-hexanediol and bis(2-hydroxyethyl)hydroquinone, triols such as 1,2,4-, 1,3,5-trihydroxycyclohexane, glycerol and trimethylolpropane and low molecular weight hydroxyl-comprising polyalkylene oxides based on ethylene oxide and/or 1,2-propylene oxide and the abovementioned diols and/or triols as starter molecules.

The blowing agents include physical blowing agents and/or chemical blowing agents.

Physical blowing agents are compounds which are inert toward the starting components and are usually liquid at room temperature and vaporize under the conditions of the urethane reaction. Physical blowing agents also include compounds which are gaseous at room temperature and are introduced into or dissolved in the starting components under pressure, for example carbon dioxide, low-boiling alkanes, fluoroalkanes and fluoroolefins.

The physical blowing agents are usually selected from the group consisting of alkanes and cycloalkanes having at least 4 carbon atoms, dialkyl ethers, esters, ketones, acetals, fluoroalkanes, fluoroolefins having from 1 to 8 carbon atoms and tetraalkylsilanes having from 1 to 3 carbon atoms in the alkyl chain, in particular tetramethylsilane.

Examples which may be mentioned are propane, n-butane, isobutane and cyclobutane, n-pentane, isopentane and cyclopentane, cyclohexane, dimethyl ether, methyl ethyl ether, methyl butyl ether, methyl formate, acetone and fluoroalkanes which can be degraded in the troposphere and therefore do not damage the ozone layer, e.g. trifluoromethane, difluoromethane, 1,1,1,3,3-pentafluorobutane, 1,1,1,3,3-pentafluoropropane, 1,1,1,2-tetrafluoroethane, difluoroethane and heptafluoropropane. Examples of fluoroolefins are 1-chloro-3,3,3-trifluoropropene, 1,1,1,4,4,4-hexafluorobutene. The physical blowing agents mentioned can be used alone or in any combinations with one another.

Chemical blowing agent includes water, formic acid, et al.

As catalysts, it is possible to use all compounds which accelerate the isocyanatepolyol reaction. Such compounds are known and are described, for example, in “Kunststoffhandbuch, volume 7, Polyurethane”, Carl Hanser Verlag, 3rd edition 1993, chapter 3.4.1. These comprise amine-based catalysts and catalysts based on organic metal compounds.

As catalysts based on organic metal compounds, it is possible to use, for example, organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate, and also bismuth carboxylates e.g. bismuth(III) neodecanoate, bismuth 2-ethylhexanoate and bismuth octanoate, or alkali metal salts of carboxylic acids, e.g. potassium acetate or potassium formate.

The term foam stabilizer refers to materials which promote formation of a regular cell structure during foam formation. Examples which may be mentioned are: silicone-comprising foam stabilizers such as siloxane-oxyalkylene copolymers and other organopolysiloxanes. Alkoxylation products of fatty alcohols, oxo alcohols, fatty amines, alkylphenols, dialkylphenols, alkylcresols, alkylresorcinol, naphthol, alkylnaphthol, naphthylamine, aniline, alkylaniline, toluidine, bisphenol A, alkylated bisphenol A, polyvinyl alcohol and also further alkoxylation products of condensation products of formaldehyde and alkylphenols, formaldehyde and dialkylphenols, formaldehyde and alkylcresols, formaldehyde and alkylresorcinol, formaldehyde and aniline, formaldehyde and toluidine, formaldehyde and naphthol, formaldehyde and alkylnaphthol and also formaldehyde and bisphenol A or mixtures of two or more of these foam stabilizers can also be used.

As further additives, it is possible to use flame retardants, plasticizers, further fillers and other additives such as antioxidants, antistatic agent, et al.

In the context of the present invention, packing factor is defined as molded density (MD)/free rise density (FRD), as described in WO 2012/076375A1 which is incorporated herein by reference. Molded density (MD) means the density determined by weighing the samples and dividing the weight by the measured volume of the samples. Free rise density (FRD) means the density measured from a free rising foam (at ambient air-pressure) produced from a total system formulation weight of 12 grams or more. FRD is reported in kg/m³. As known for those skilled in the art, the higher packing factor, the higher the proportion of the blowing agents used.

Generally, a reaction mixture for preparing PU foam is placed into a mold cavity at a packing factor of 1.1-1.9, while according to the present invention, the reaction mixture is placed into the pressurizable chamber at a packing factor of 2.0-4.0, preferably 2.5-3.5, more preferably 2.5-3.0 due to the use of relative larger proportion of blowing agents in the preparation of polyurethane foams.

Since relative larger proportion of blowing agents are used in the preparation of polyurethane foams according to the present invention, the polyurethane foams can form fast. But there are no overflowed foams because additional pressure is used in the preparation of polyurethane foams according to the present invention. In addition, the polyurethane foams according to the present invention have a uniform cell relative to the polyurethane foams in the art, and thus can result in superior physical properties.

The additional pressure is 0.001 MPa-0.2 MPa, preferably 0.01 MPa-0.1 MPa, more preferably 0.03 MPa-0.08 MPa. Herein, the expression “additional pressure” means a pressure in addition to atmospheric pressure.

The additional pressure comprises a pressure produced by adding gas into the pressurizable chamber. Generally, the additional pressure is produced by adding gas into the pressurizable chamber before, during and/or after the addition of the reaction mixture. Said gases include, but not limited to, air, nitrogen, carbon dioxide, helium, argon, oxygen, low boiling point physical blowing agents and a combination thereof.

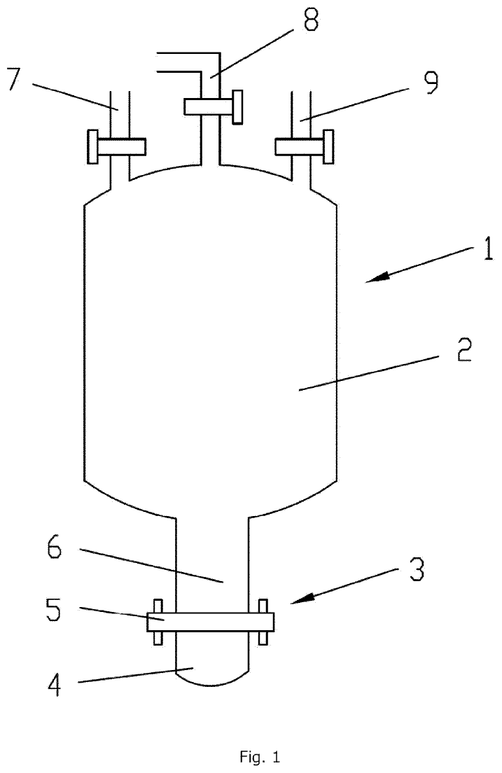

The PU foam according to the present invention can be prepared by a common method in the art by reacting each component in a reactor, such as a reactor (1) shown in FIG. 1. Specially, isocyanates, isocyanate-reactive compounds and blowing agents and optionally additives such as catalysts are mixed in a container, and then the resulted mixture is placed into part 4 of the reactor, and then said part 4 is connected to part 6 by a sealing flange 5. The PU foam forms in the part 3 of the reactor wherein said part 3 includes part 4 and part 6. Additional pressure can be input into the buffer part 2 of the reactor through inlet 8. In addition, outlet 7 is connected to a pressure meter for measuring the pressure in the reactor and outlet 9 is used to release the pressure in the reactor.

The present invention also relates to use of the polyurethane foam in refrigerator insulation material, water heater insulation material, reefer insulation material, sandwich panel insulation material, cooler box insulation material, automotive seating, automotive carpet, engineer cover, steering wheel, instrument panel, sofa, pillow, shoe soles and ball, and the like.

### EXAMPLES

The present invention is now further illustrated by reference to the following examples, however, the examples are used for the purpose of explanation and not intended to limit the scopes of the present invention.

All materials used in the examples are available in the market, and their amounts used are listed in Tables 1 and 2. All the examples are targeted for density 150 kg/m³ of mold foam (i.e. MD=150 kg/m³).

### Comparative Example 1

Component A and component B according to Table 1 are mixed in a reactor for 3 s with stirring, and then 12 g of the mixture is placed into the reactor at atmospheric pressure, as shown in FIG. 1. After 126 s, the foaming volume reaches 80 ml. After 203 s, the final foaming volume reaches 120 ml when the foam stops growing.

SEM (scanning electron microscope) graph of the resulted foam is shown as FIG. 2.

TABLE 1

| | | | | NCO |
|---|---|---|---|---|
| | Weight | OH value | | content |
| Component A | (g) | (mg KOH/g) | Functionality | (%) |
| Phthalic anhydride | 30 | 300 | 2 | |
| based polyester | | | | |
| polyol | | | | |
| Saccharose and | 55 | 490 | 4.3 | |
| glycerin initiated | | | | |
| polyether polyol | | | | |
| Dipropylene glycol | 10 | 836 | 2 | |
| Amine catalyst | 2 | | | |
| Silicon surfactant | 3 | | | |
| (Niax silicone L- | | | | |
| 6988 from | | | | |
| Momentive) | | | | |
| Physical blowing | 9 | | | |
| agent (1,1,1,3,3- | | | | |
| pentafluoropropane) | | | | |
| Component B | | | | |
| Poly MDI (Lupranate | | | 2.7 | 31.5 |
| M20S from | | | | |
| BASF) | | | | |
| Index 120 | | | | |

| | |
|---|---|
| FRD (kg/m³) | 100 |
| Packing factor | 1.5 |

### Comparative Example 2

Component A and component B according to Table 2 are mixed in a reactor for 3 s with stirring, and then 12 g of the mixture is placed into the reactor at atmospheric pressure, as shown in FIG. 1. After 93 s, the foaming volume reaches 80 ml. After 212 s, the foaming volume reaches 200 ml when the foam stops growing.

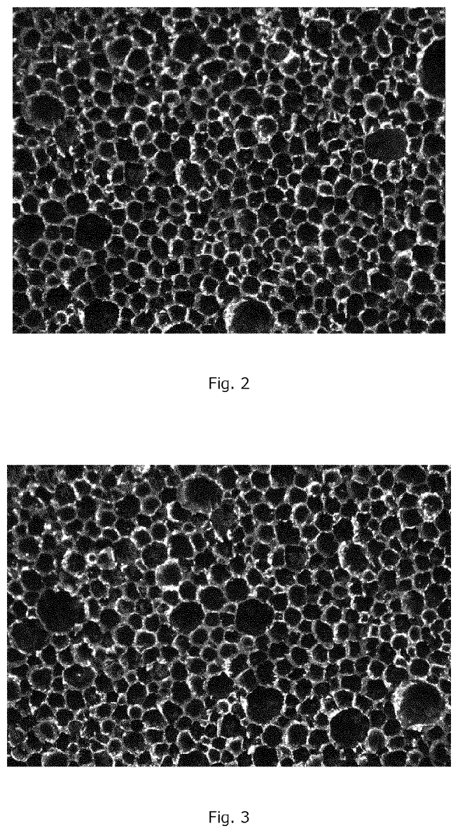

SEM (scanning electron microscope) graph of the resulted foam is shown as FIG. 3.

TABLE 2

| | | | | NCO |
|---|---|---|---|---|
| | Weight | OH value | | content |
| Component A | (g) | (mg KOH/g) | Functionality | (%) |
| Phthalic anhydride | 30 | 300 | 2 | |
| based polyester | | | | |
| polyol | | | | |
| Saccharose and | 55 | 490 | 4.3 | |
| glycerin initiated | | | | |
| polyether polyol | | | | |
| Dipropylene glycol | 10 | 836 | 2 | |
| Amine catalyst | 2 | | | |
| Silicon surfactant | 3 | | | |
| (Niax silicone L-6988 | | | | |
| from Momentive) | | | | |
| Physical blowing | 17 | | | |
| agent (1,1,1,3,3- | | | | |
| pentafluoropropane) | | | | |
| B component | | | | |
| Poly MDI (Lupranate | | | 2.7 | 31.5 |
| M20S from BASF) | | | | |
| Index 120 | | | | |

| | |
|---|---|
| FRD (kg/m³) | 60 |
| Packing factor | 2.5 |

### Comparative Example 3

Component A and component B according to Table 1 are mixed in a reactor for 3 s with stirring, and then 12 g of the mixture is placed into the reactor as shown in FIG. 1, and 0.03 MPa of additional pressure is added and kept constant. After 223 s, the final foaming volume reaches 70 ml when the foam stops growing.

### Example 1

Component A and component B according to Table 2 are mixed in a reactor for 3 s with stirring, and then 12 g of the mixture is placed into the reactor as shown in FIG. 1 with 0.03 MPa of additional pressure, and at the same time the additional pressure is releasing fast (about 20 s) until the foaming volume reaches 80 ml (about 108 s) at which time the pressure inside the reactor was 1 atmosphere (i.e. without additional pressure). When the foam grows to 100 ml, an additional pressure of 0.03 Mpa is added into the reactor and kept constant. After 162 s, the final foaming volume reaches 120 ml when the foam stops growing.

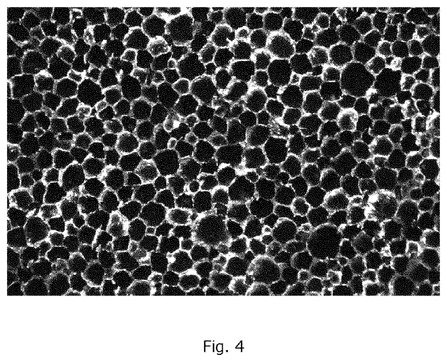

SEM (scanning electron microscope) graph of the resulted foam is shown as FIG. 4.

### Example 2

Component A and component B according to Table 2 are mixed in a reactor for 3 s with stirring, and then 12 g of the mixture is placed into the reactor as shown in FIG. 1 without additional pressure. After 62 s, the foaming volume reaches 80 ml. When the foam grows to 100 ml, an additional pressure of 0.03 Mpa is added into the reactor and kept constant. After 113 s, the final foaming volume reaches 120 ml when the foam stops growing.

### Example 3

Component A and component B according to Table 2 are mixed in a reactor for 3 s with stirring, and then 12 g of the mixture is placed into the reactor as shown in FIG. 1 with the pressure being 0.95 atm. After 46 s, the foaming volume reaches 80 ml. When the foam grows to 100 ml, pressure is increased to 0.04 Mpa (gauge) and kept constant. After 105 s, the final foaming volume reaches 120 ml when the foam stops growing.

The results show that the rising times of foams according to the present invention are shorter than those of comparative examples, and at the same time, the cells of foams according to the present invention are more uniform than those of comparative examples, as shown in FIGS. 2-4.

It will be apparent to those skilled in the art that various modifications and variations can be made in the present invention without departing from the scope or spirit of the present invention. Thus, it is intended that the present invention cover such modifications and variations as come within the scope of the appended claims and their equivalents.

1. A method for preparing polyurethane foams, comprising:
(1) placing a reaction mixture into a pressurizable chamber, and
(2) polymerizing the reaction mixture at an additional pressure,
wherein the reaction mixture comprises an isocyanate, an isocyanate-reactive compound and a blowing agent, and the reaction mixture is placed into the pressurizable chamber at a packing factor of 2.0-4.0.

2. The method according to claim 1, wherein the reaction mixture is placed into the pressurizable chamber at a packing factor of 2.5-3.5.

3. The method according to claim 1, wherein the additional pressure is 0.001 MPa-0.2 MPa.

4. The method according to claim 1, wherein the additional pressure comprises a pressure produced by adding gas into the pressurizable chamber.

5. The method according to claim 4, wherein the additional pressure is produced by adding gas into the pressurizable chamber before, during and/or after the addition of the reaction mixture.

6. The method according to claim 1, wherein the isocyanates include tolylene diisocyanate (TDI), diphenylmethane diisocyanate (MDI), polymeric diphenylmethane diisocyanate (PMDI), 1, 5-Naphthalene diisocyanate (NDI), Dimethylbiphenyl diisocyanate (TODI), Hexamethylene diisocyanate (HDI), Isophorone diisocyanate (IPDI), Dicyclohexylmethane diisocyanate (H12MDI), Meta-tetramethylxylylene diisocyanate (TMXDI), isocyanate group terminated prepolymers, or a mixture thereof.

7. The method according to claim 1, wherein the isocyanate-reactive compound comprises polyether polyol, polyester polyol or a combination thereof.

8. The method according to claim 1, wherein the blowing agent comprises a physical blowing agent and/or chemical blowing agent.

9. A polyurethane foam prepared by the method of claim 1.

10. A method of using a polyurethane foam according to claim 9, the method comprising using the polyurethane foam in a refrigerator insulation material, a water heater insulation material, a reefer insulation material, a sandwich panel insulation material, a cooler box insulation material, an automotive seating, an automotive carpet, an engineer cover, a steering wheel, an instrument panel, a sofa, a pillow, shoe soles, or a ball.

11. The method according to claim 1, wherein the reaction mixture is placed into the pressurizable chamber at a packing factor of 2.5-3.0.

12. The method according to claim 1, wherein the additional pressure is 0.01 MPa-0.1 MPa.

13. The method according to claim 1, wherein the additional pressure is 0.03 MPa-0.08 MPa.
